(19) United States
(12) Patent Application Publication
(10) Pub. No.: US 2022/0068068 A1
(43) Pub. Date: Mar. 3, 2022

(54) Security access

(71) Applicant: John Gomes Bento, Rio Vista, CA (US)

(72) Inventor: John Gomes Bento, Rio Vista, CA (US)

(21) Appl. No.: 16/974,350

(22) Filed: Aug. 29, 2020

(51) Int. Cl. G07C 9/30; G08B 17/10

(52) U.S. Cl. CPC G07C 9/30; G08B 17/10

(57) ABSTRACT

This invention consists of 2 main parts:

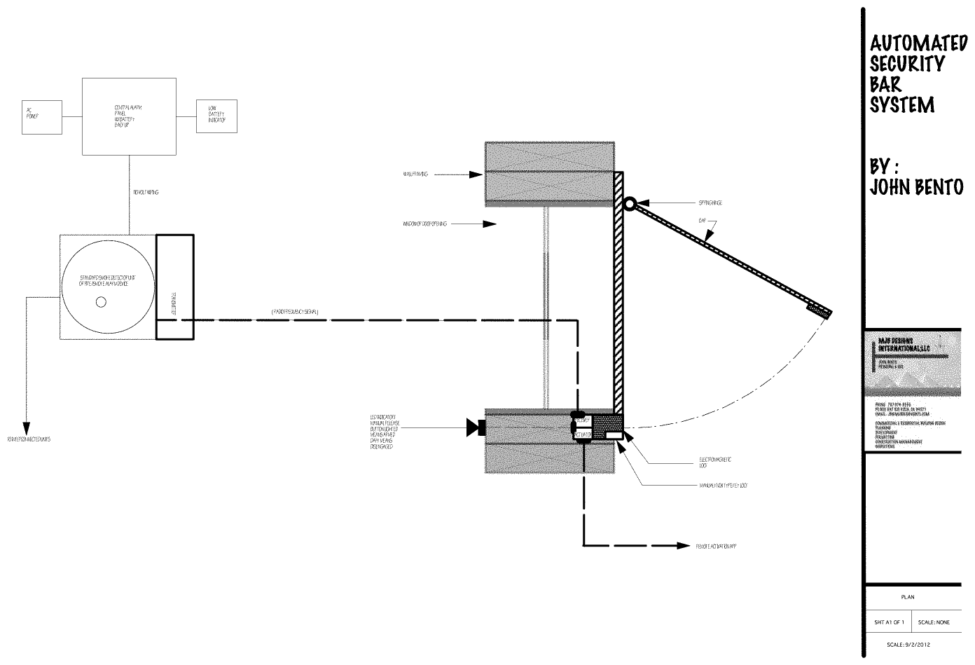

1. a smoke detector or fire/smoke alarm detection unit which includes a wireless transmitter. The wireless transmitter communicates with an electronic locking mechanism which is incorporated into each security bar assembly unit found at all the doors and windows in a building. The locking mechanism includes a receiver and actuator incorporated into the bar assembly unit. The wireless transmitter communicates with the receiver. The security bar assembly also includes spring hinges as well as a battery back up and low battery warning system featuring both a flashing light (for the hearing impaired) and a buzzer (for the visually impaired. There is also a manual release button. In the event that the smoke detection unit is activated, the wireless transmitter sends a signal to the receiver which in turn activates the electronic lock to the open position. Since smoke detectors and fire/smoke alarm detection units are interconnected, all the bars throughout the building would be activated regardless of where the fire originates thus allowing multiple exiting options for the occupants and multiple ingress options for emergency responders. The spring hinges then cause the bars to swing to the open position. The integrated battery provides power to activate the locking mechanism in case of loss of ac power. The low battery warning system provides a flashing light (for the hearing impaired) as well as a buzzer (for the visually impaired) to indicate that the battery needs replacing. The manual release button provides a means of egress in the event that both ac and battery power are non existent.

2. The electronic lock system also includes an actuator which allows for wireless communication via the internet using a mobile phone or computer app which would be installed on the devices of local emergency responders.

Each security bar assembly would be programmed with its own unique access code. This code would be provided to and filed with the local emergency dispatch center. The app would consist of a numeric key pad that when the user punches the correct code sends a signal to the actuator in the security bar assembly activating it into the open position. In the event of a 911 call, dispatch would provide the emergency responders with the access code and they would in turn use their mobile device to remotely activate the security bar assembly to the open position. The system would also include an integrated Knox type lock to provide a manual access option for emergency response personnel in the event of an electrical power outage and the battery has run dry or in the event of a more widespread loss of power.

### INVENTION SUMMARY

### Premise

Occupants of residential and commercial buildings desire security in their surroundings. At the same time, emergency personnel desire and need unencumbered access to buildings in the event of an emergency. The presence of security bars creates a conflict between these two desires. Current code requires that a security bar system include an interior latch release mechanism to open the bars; however, this presupposes that one the building is occupied and/or two, the occupants are coherent and ambulatory enough to operate the latch. If not, the system still poses an obstacle to emergency response personnel. While most Fire Departments have equipment to cut and or remove the bars, this takes time and time is of the essence in emergency response, furthermore, police and EMT personnel do not carry the necessary equipment to remove the bars and therefore would have to rely on assistance from the local fire department to gain access.

### Intent

My idea provides for both the automatic unlatching of the bars in the event of a fire and remote controlled access in the event of other emergency situations. The intent of this device is to provide an automatic mechanism that will allow the unlocking of the security bars be they located on doors or windows and in residential or commercial construction. The operation of the device enables the occupants to egress in the event of a fire and enables emergency responders to enter upon arrival on scene in the without having to use equipment and potentially precious time to cut through the bars. The presence of this system allows the security bars to provide the necessary desired protection to the occupants without sacrificing their safety in case of fire or medical emergency whereby the bars then become an impediment to responding emergency personnel who have to spend valuable time cutting through the bars to gain access. The system is thus independent of the occupants of the building.

### DESIGN/FUNCTION

The design of this system works in two ways:
1. it incorporates a security bar system located at each door and window that includes a smoked detector or fire/smoke alarm unit with a wireless transmitter paired with an electronic lock mechanism with a receiver, actuator and spring hinges. The system also includes a battery back up and low battery warning system featuring both a flashing light (for the hearing impaired) and a a buzzer (for the visually impaired. There is also a manual release button.
Activation of the smoke detectors and or fire alarm triggers the electronic lock to switch to open mode. The spring hinges in turn swing the bars into the open position. The battery provides power to activate the lock in case of loss of power. The low battery indicator warns the user if the battery is low or needs replacing. Since smoke detectors are interconnected, all the bars throughout the building would be activated regardless of where the fire originates thus allowing multiple exiting options for the occupants and multiple ingress options for emergency responders.
2. It provides for the remote unlatching of the bars via a phone/computer app which would send the unlock code to the actuator located on the system. The app would be operated by local emergency response personnel when they are dispatched. The local dispatch center would have the remote code information on file and would provide that code to the responding emergency response personnel allowing them to activate the bars remotely before arriving on scene.

The system would also include an integrated Knox type lock to provide a manual access option for emergency response personnel in the event of an electrical power outage and the battery has run dry or in the event of a more widespread loss of power.

### SUMMATION

Due to the crime rate in some areas of our country as well as internationally, we are faced with having to compromise between security for our residential and commercial structures and protection from fire and medical emergencies for the occupants. Initially security bars had no mechanism for emergency release; therefore, while providing security in an emergency situation, the bars became an impediment to the occupants getting out and emergency personnel getting in, thus causing harm and even death to the very people the bars were installed to protect. As a result, the building code was amended to require that there be an internal release mechanism on the bars to afford escape by the occupants in case of an emergency. While the manual release is a good first step, that is all it is. The internal release mechanism presupposes that there is someone home or that the person will not be so incapacitated by a fire or medical situation that they will be able to operate the release mechanism. In either case, responding emergency personnel are faced with having to spend precious minutes removing the bar barrier to access the structure; minutes that might mean the difference in saving the individual and or the structure. Although California law now requires that all residences have sprinkler systems thus diminishing the danger of fire, this is not true of other states or other countries nor is it applicable to all other occupancies. Furthermore, the requirement is for new construction, it is not required for existing structures and is only required for major remodels depending upon the local jurisdiction so the need for automated access is still vital. In addition, sprinkler systems do nothing with respect to a medical emergency where unfettered access is still a necessity. Lastly as mentioned earlier, there is discussion to require, in future building codes, an external release mechanism for these security bars so that emergency personnel can access the structure quickly. However, providing an external release mechanism that would allow easy access for emergency personnel and at the same time deter and prevent criminal entry may prove difficult and would undermine the point of the security bars in the first place. The intent of this system is to provide the desired security without sacrificing the ability to egress or ingress the structure in the case of an emergency.

### DRAWING DESCRIPTION

The attached drawing is a line diagram showing a smoke detector/smoke alarm/transmitter unit hardwired into a central alarm panel. It shows how the transmitter communicates with the electromagnetic lock/receiver/actuator unit. It shows the security bar is operable by the electromagnetic lock/receiver/actuator unit. The drawing also shows how the unit is operable via a remote control app.

1. A device to automatically and remotely activate a security bar assembly located at a window, door or other structure opening comprising:
A fire/smoke alarm detection unit with an integrated wireless transmitter. Said transmitter to communicate in a wireless fashion with a a security bar assembly located at the openings. Said bar assembly to comprise the following integrated components:
a receiver to communicate in a wireless fashion with the transmitter, an electromagnetic locking/unlocking assembly to lock and unlock the bar assembly,
spring hinges to release the bar assembly upon activation, a battery back up with 2 modes of low battery warning-visual and audible, an actuator, a manual release button and a keyed lock.
Said device also includes a computer or mobile device app to remotely communicate with the actuator.
Said app to consist of a numeric keypad which will with the proper code input will send an activation signal to the electronic lock,
unlocking it.
Said device to also include an integrated exterior lockbox to provide a manual access option for emergency response personnel.
Said lock box shall contain a master key which would open the keyed lock.
